(19) United States
(12) Patent Application Publication
(10) Pub. No.: US 2026/0189275 A1
(43) Pub. Date: Jul. 2, 2026

(54) DYNAMIC TRANSMIT PORT SELECTION

(71) Applicant: Apple Inc., Cupertino, CA (US)

(72) Inventors: Sriram Subramanian, San Jose, CA (US); Abhijit Kamat, San Diego, CA (US); Alosious Pradeep Prabhakar, Singapore (SG); Bilal Zafar, San Diego, CA (US); Kapil Ganesan, Campbell, CA (US); Mohammed Sadique, Auburn (AU); Nishit Khara, San Jose, CA (US); Sanjeevi Balasubramanian, San Jose, CA (US); Shiva Krishna Narra, San Jose, CA (US); Vijay Venkataraman, San Jose, CA (US); Vishwanth Kamala Govindaraju, Mountain View, CA (US)

(21) Appl. No.: 19/405,501

(22) Filed: Dec. 2, 2025

Related U.S. Application Data
(60) Provisional application No. 63/740,135, filed on Dec. 30, 2024.

(51) Int. Cl. H04B 7/06; H04L 5/00; H04W 24/10

(52) U.S. Cl. CPC H04B 7/061; H04L 5/0051; H04W 24/10

(57) ABSTRACT

The present disclosure generally relates to dynamic learning-based transmit port selection. One aspect of the present disclosure relates to a method including: identifying one or more operating conditions of a user equipment (UE); selecting a downlink reference signal type based on at least one of the one or more operating conditions or a periodicity of the downlink reference signal type; and selecting an uplink transmit port based on measurements of reference signals of the selected downlink reference signal type. Another aspect of the present disclosure relates to a method including: selecting a set of candidate transmit ports from a plurality of antenna ports according to one or more operating criteria; selecting an uplink transmit port from the set of candidate transmit ports based on one or more operating conditions of the uplink transmit port; and using the selected uplink transmit port for a transmit port evaluation period.

### CROSS-REFERENCE TO RELATED APPLICATIONS

This application claims priority to U.S. Provisional Ser. No. 63/740,135, filed Dec. 30, 2024, the entirety of which is incorporated herein by reference.

### TECHNICAL FIELD

The present disclosure relates generally to wireless communication, and more specifically to dynamic uplink transmit port selection.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the ETSI Third Generation Partnership Project (3GPP). The wireless communication networks facilitate mobile broadband service using technologies such as Orthogonal Frequency-Division Multiple Access (OFDMA), Multiple Input Multiple Output (MIMO), advanced channel coding, massive MIMO, beamforming, and/or other features.

### SUMMARY

One aspect of the present disclosure relates to a method including: identifying one or more operating conditions of a user equipment (UE); selecting a downlink reference signal type based on at least one of the one or more operating conditions of the UE or a periodicity of the downlink reference signal type; and selecting an uplink transmit port from a set of antenna ports based on measurements of one or more reference signals of the selected downlink reference signal type.

Another aspect of the present disclosure relates to a method including: selecting a set of candidate transmit ports from a set of antenna ports according to one or more operating criteria; selecting an uplink transmit port from the set of candidate transmit ports based on one or more operating conditions of the uplink transmit port; and using the selected uplink transmit port for a transmit port evaluation period.

Another aspect of the present disclosure relates to an apparatus including: one or more processors; and memory storing instructions that, when executed by the one or more processors, cause the apparatus to perform the following operations: identifying one or more operating conditions of a UE; selecting a downlink reference signal type based on at least one of the one or more operating conditions of the UE or a periodicity of the downlink reference signal type; and selecting an uplink transmit port from a set of antenna ports based on measurements of one or more reference signals of the selected downlink reference signal type.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIGS. 2A-2C illustrate flowcharts of an example method for reference signal selection, according to some implementations.

FIGS. 3A-3C illustrate flowcharts of another example method for antenna port selection, according to some implementations.

FIGS. 4 and 5 illustrate flowcharts of other example methods for antenna port selection, according to some implementations.

FIG. 6 illustrates an example user equipment (UE), according to some implementations.

FIG. 7 illustrates an example access node, according to some implementations.

### DETAILED DESCRIPTION

In some wireless communication systems, a user equipment (UE) may be configured to predict uplink pathloss based on a received power of downlink signals across one or more antenna ports. As described herein, the term pathloss refers to the reduction in signal strength or power density of a radio wave as it propagates through space. The UE may select an antenna port to use for uplink transmission based on the predicted uplink pathloss derived from the downlink reference signals. However, the received power measured by the UE can vary according to the periodicity at which each reference signal is transmitted. This can affect which antenna port is ultimately selected by the UE. For example, a first antenna port may appear more favorable when measurements of high-resolution (e.g., more frequently transmitted) reference signals are considered, while a second antenna port may appear more favorable when measurements of low-resolution (e.g., less frequently transmitted) reference signals are considered. Evaluating all antenna ports and reference signal types during transmit port selection can be time consuming and power intensive.

Some aspects of the present disclosure relate to evaluating which reference signals to use for channel estimation. In some implementations, the UE may selectively use high-resolution reference signals, including (but not limited to) Tracking Reference Signals (TRS), Channel State Information Reference Signals (CSI-RS), Phase-Tracking Reference Signals (PTRS), or the like. These high-resolution reference signals may allow the UE to estimate channel conditions with higher granularity. After selecting a particular reference signal type to use for channel estimation, the UE may determine whether fluctuations of the selected reference signal across a given time period are above a threshold. If fluctuations of the selected reference signal exceed the threshold for a particular antenna port, the UE may select another reference signal type to use for channel estimation.

Other aspects of the present disclosure relate to determining which antenna ports to evaluate (e.g., down select) for uplink antenna selection. For example, if there is an imbalance in Reference Signal Received Power (RSRP) between antenna ports of the UE, antenna ports with the highest RSRP and lowest imbalance may be evaluated further. Similarly, if there is a difference in Total Radiated Power (TRP) across antenna ports of the UE, antenna ports with the highest TRP may be evaluated further. Similarly, if Body Proximity Sensing (BPS) measurements indicate that some antenna ports of the UE are occluded (e.g., blocked or obstructed), these antenna ports can be eliminated from consideration, even if they have more favorable RSRP measurements.

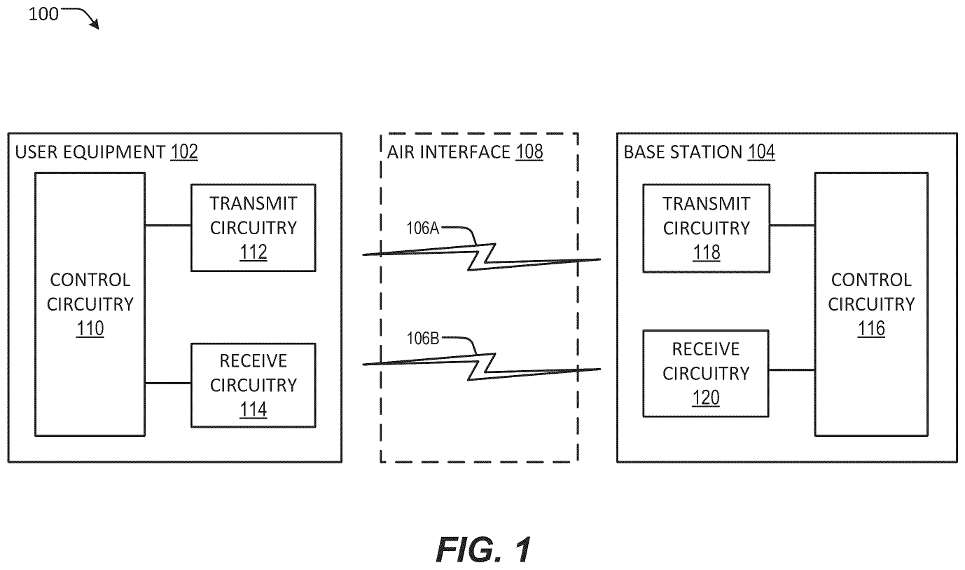

FIG. 1 illustrates a wireless network 100. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 is a Standalone (SA) network, e.g., that incorporates Fifth Generation (5G) New Radio (NR). In some other implementations, the wireless network 100 is a Non-Standalone (NSA) network that incorporates Long Term Evolution (LTE) and 5G NR. In these implementations, the wireless network 100 may be an Evolved Universal Terrestrial Radio Access (E-UTRA) NR Dual Connectivity (EN-DC) network, or an NR-EUTRA Dual Connectivity (NE-DC) network. Furthermore, wireless networks implementing one or more other types of communication standards are possible, including future 3GPP systems (e.g., Sixth Generation (6G)), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include Radio Frequency (RF) circuitry and/or Front-End Module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For example, the control circuitry 110 can select a downlink reference signal type to use for uplink antenna port selection based on a channel state of the UE 102.

The transmit circuitry 112 can perform various operations described herein. Additionally, the transmit circuitry 112 may transmit using a plurality of multiplexed uplink physical channels. The plurality of uplink physical channels may be multiplexed, e.g., according to Time Division Multiplexing (TDM) or Frequency Division Multiplexing (FDM), and in some implementations, along with Carrier Aggregation (CA). The transmit circuitry 112 may be configured to receive block data from the control circuitry 110 for transmission on the air interface 108.

The receive circuitry 114 can perform various operations described herein. For example, the receive circuitry 114 can receive a Radio Resource Control (RRC) message that configures one or more downlink reference signals for the UE 102. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with CA. The transmit circuitry 112 and the receive circuitry 114 may transmit and receive, respectively, both control data and content data (e.g., messages, images, video, and the like) structured within data blocks that are carried by the physical channels.

FIG. 1 also illustrates the base station 104. In some implementations, the base station 104 may be a 5G Radio Access Network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, Advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink interface and may include one or more logical channels, including but not limited to a Physical Sidelink Control Channel (PSCCH), a Physical Sidelink Discovery Channel (PSDCH), and a Physical Sidelink Broadcast Channel (PSBCH).

The techniques described herein generally relate to selecting transmit (Tx) ports for uplink transmissions. Currently, the UE 102 may predict uplink pathloss based on the received power of downlink signals across one or more antenna ports and choose an antenna port that is oriented toward the destination or recipient device (e.g., the base station 104). The uplink path is measured at the base station 104 (also referred to as a gNB), so the UE 102 may not utilize any uplink metrics to predict the uplink path. In Frequency Division Duplexing (FDD) bands, downlink and uplink pathloss may not be reciprocated, especially with high receive (Rx) and transmit (Tx) frequency separation. For antenna cluster-based selection, when the power budget is utilized on an antenna port with favorable conditions but the UE 102 has to reduce transmit power to comply with Specific Absorption Rate (SAR) regulations, the UE 102 may determine whether an antenna port with less favorable conditions in another cluster has a full power budget.

For reference signal selection, the network may support various types of reference signals, including (but not limited to) Synchronization Signal Blocks (SSB), CSI-RS, and TRS, the granularity and power of which may vary across antenna ports. For example, on one antenna port (Rx1), SSB RSRP may be lower than TRS RSRP, e.g., by approximately 7 dB. On another antenna port (Rx3), SSB RSRP may be higher than TRS RSRP, e.g., by approximately 3 dB. In some cases, TRS RSRP is more stable than SSB RSRP due to Packet Data Protocol (PDP) processing.

If the UE 102 has multi-Subscriber Identity Module (SIM) capabilities, the UE 102 may be configured to select an optimal antenna port for each SIM in a dual-SIM use case. When the UE transmits uplink signals to the base station 104, the base station 104 may not report the Signal to Noise Ratio (SNR) of the uplink signals back to the UE 102 or provide feedback for Sounding Reference Signal (SRS) transmissions from the UE 102. Instead, the network (e.g., the base station 104) may automatically reduce the uplink Modulation and Coding Scheme (MCS) allocation for the UE 102 to ensure that the uplink Block Error Rate (BLER) is below a threshold (such as 10%). In some frequency bands, the TRP or Total Isotropic Sensitivity (TIS), also referred to as Rx sensitivity, may differ. All of these factors can affect uplink transmit port selection at the UE 102.

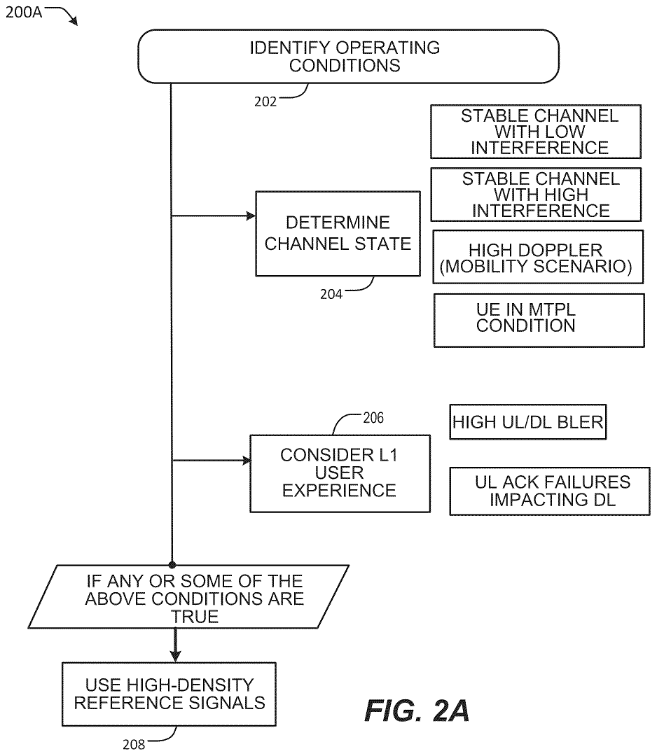

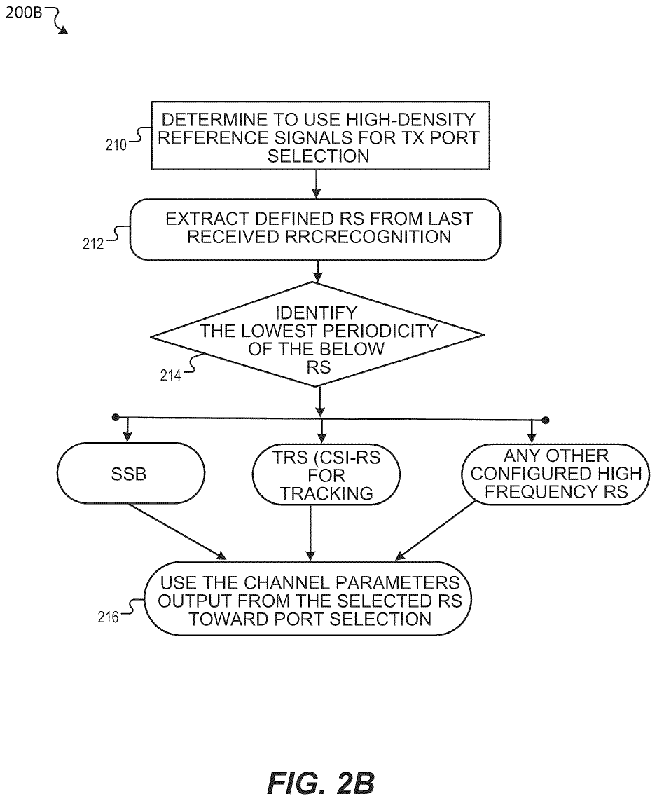

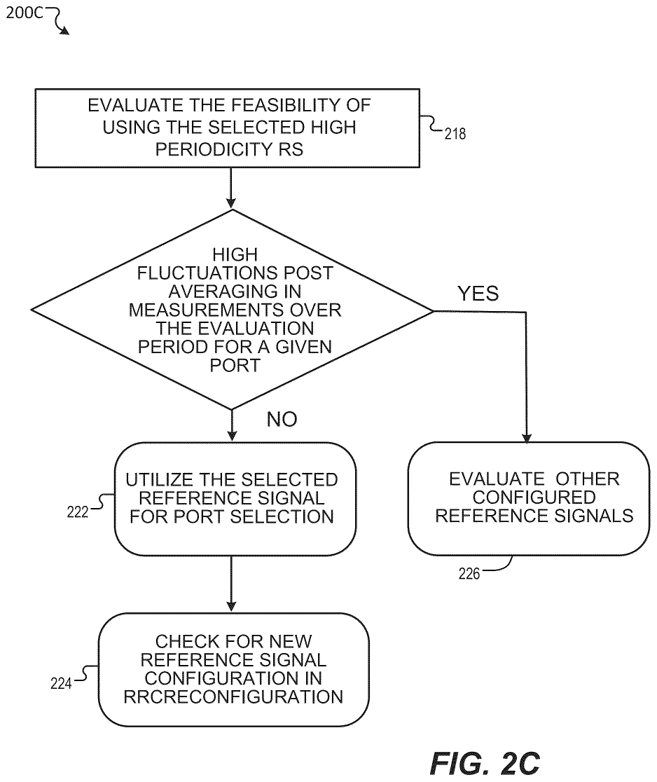

FIGS. 2A-2C illustrate flowcharts of an example method for reference signal selection, according to some implementations. The method is described with respect to flowcharts 200A, 200B, and 200C shown respectively in FIGS. 2A, 2B, and 2C. Some aspects of the method can be implemented by the UE 102 of FIG. 1. Based on mobility conditions of a UE, more granularly scheduled Demodulation Reference Signal (DMRS) or TRS can be used to predict the downlink channel quality for a given antenna port. A higher imbalance in SSB RSRP across transmit ports may prompt the UE to evaluate other reference signal types for channel estimation.

Unlike LTE, 5G NR does not support cell-specific reference signals (CRS). In 5G systems, the network configure reference signals that a device can monitor and report on. SSBs are typically configured for higher level signal reporting and L3-related events. These SSBs are typically transmitted at an interval of 20 ms. In LTE, CRS are transmitted more frequently. Other reference signals, such as CSI-RS, TRS, and PTRS, can be configured as needed. As described herein, TRS is a downlink reference signal that allows the UE to track time/frequency variations with a high resolution. The UE can derive RSRP measurements from the aforenoted reference signals and use these measurements for various internal processes, such as identifying an optimal antenna for uplink transmission.

Using high-resolution reference signals for antenna port selection may result in greater power consumption, so these reference signals can be selectively used when certain conditions are met. First, the UE may determine the status of various operating conditions, such as doppler shift, signal quality, interference, uplink Maximum Transmit Power Level (MTPL), etc. In scenarios with high doppler shift (e.g., high mobility), low RSRP, or high interference, the UE may report these conditions to the network and request further high-resolution channel measurements for UE-centric algorithms. Other conditions, such as high BLER or uplink BLER, can also trigger this request.

After power up or cell change, the UE may identify the network-configured reference signals that can vary amongst cells, including (but not limited to) SSB, CSI-RS for tracking, PTRS, and DMRS. If higher fluctuations are observed while using a particular reference signal type, the UE can use the RSRP of other configured reference signals to evaluate channel conditions at one or more antenna ports of the UE.

As shown in the flowchart 200A of FIG. 2A, the UE may decide to use more frequent reference signals by identifying (202) either a channel state of the UE or a user experience from the Layer 1 (L 1 ) perspective, or both. To assess the channel state, the UE may determine (204) whether any of the following channel conditions are met: stable channel with low interference; stable channel with high interference; high doppler shift (mobility scenario); MTPL condition (e.g., limited transmit power). The UE may also consider (206) user experience from the Layer 1 (L1) perspective, e.g., by checking for high uplink/downlink BLER or uplink acknowledgement (ACK) failures impacting the downlink. If any of these conditions are present, the UE may opt (208) to use higher-density reference signals for antenna port selection.

In the flowchart 200B of FIG. 2B, the UE may determine (210) which reference signals have been configured by parameters of the RRCReconfiguration message. To do so, the UE may extract (212) the defined reference signals from the last RRCReconfiguration message received from the network. Once complete, the UE may identify (214) the reference signal with the lowest periodicity (e.g., that is transmitted most frequently). The identified reference signal can be an SSB, a TRS or CSI-RS for tracking, or any other high frequency reference signal configured by the network. The UE may then use (216) channel parameters derived from the selected reference signal for antenna port selection.

In the flowchart 200C of FIG. 2C, the UE may compare and select a reference signal type to use for transmit port selection. First, the UE may evaluate (218) the feasibility of using the selected reference signal. If there are high fluctuations (post-averaging) in measurements over an evaluation period for a given antenna port, the UE may evaluate (226) a different reference signal configured by RRCReconfiguration (e.g., by repeating the operations of FIG. 2B for another reference signal type). Otherwise, the UE can use (222) the selected reference signal for antenna port selection. If another RRCReconfiguration message is received, the UE may check (224) for the latest configured reference signals in the new RRC configuration.

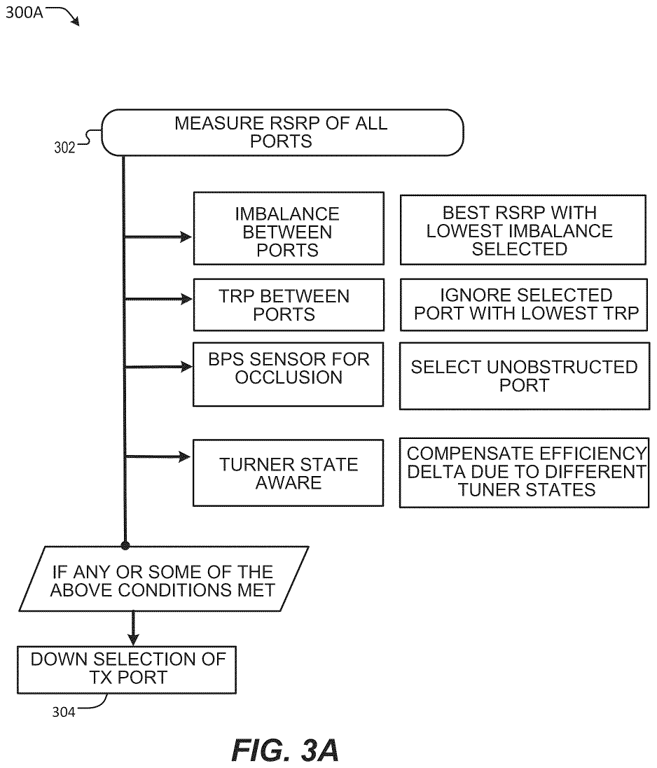

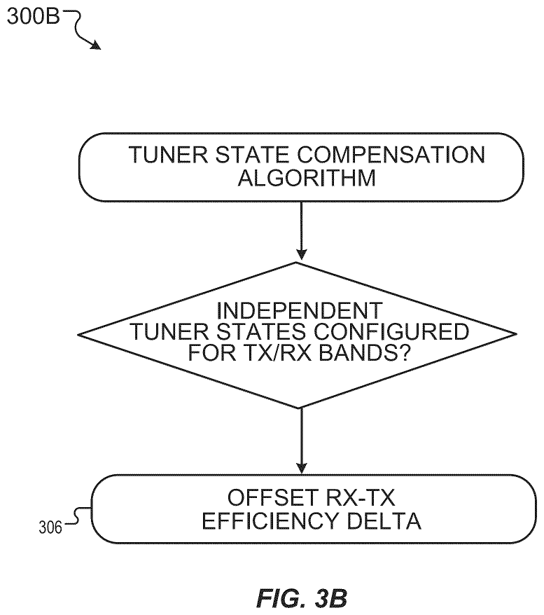

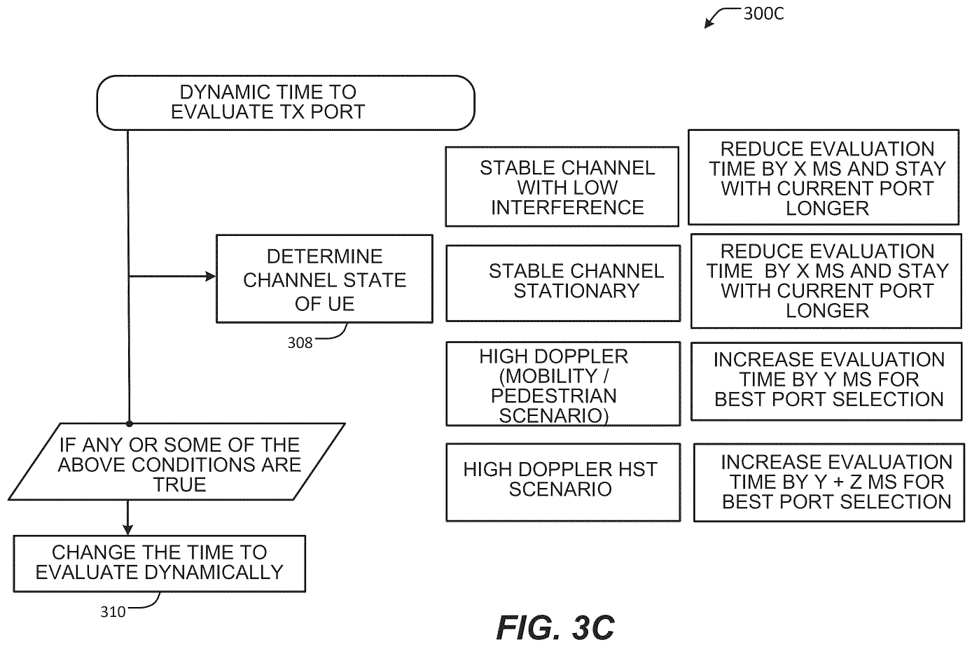

FIGS. 3A-3C illustrate flowcharts of another example method for antenna port selection, according to some implementations. The method is described with respect to flowcharts 300A, 300B, and 300C shown respectively in FIGS. 3A, 3B, and 3C. Some aspects of the method can be implemented by the UE 102 of FIG. 1. As described herein, a UE may dynamically down-select which antenna ports are evaluated during transmit port selection. After evaluating the Rx-based channel, some antenna ports can be eliminated from Tx operation if they have limitations that would effectively lower the total output power of the UE. This can happen when the UE is in a Time Division Duplexing (TDD) operating mode, where downlink and uplink pathloss are symmetric (e.g., reciprocal). Although pathloss may be reciprocated across downlink and uplink, the channel (e.g., medium) itself can vary. For Non-Terrestrial Network (NTN) and Reduced Capability (RedCap) scenarios, evaluating each antenna port can be power intensive and time consuming.

However, not all antenna ports need to be evaluated for Tx operation. Accordingly, the UE may down-select certain antenna ports for transmit port selection only if measurements at these antenna ports meet specific criteria. The dynamic time for port evaluation can be based on various channel conditions, as described below. If, for example, an RSRP imbalance between the top n antenna ports is relatively low, only the best ports with the lowest RSRP imbalance are down selected for Tx evaluation. If the TRP of the selected antenna port has a lower value, this antenna port can be eliminated from consideration because the UE is limited from a conducted level.

The UE can also use the output from a BPS sensor to detect occlusion. For example, the BPS sensor can be used to identify a given port Tx limitation due to body occlusion. For FDD frequencies with larger Rx-Tx frequency separation, more relaxed down-selection rules can be applied to evaluate more antenna ports for the uplink path. If tuner states are different for evaluating Tx ports, compensation can be applied to measurements to account for any loss/gain due to different tuner states. Some frequency bands may have an independent tuner state for Rx and Tx operations.

Generally, reference signal measurements used for Tx antenna port selection are performed with antenna tuner states optimized for Rx. For an FDD frequency with a separate tuner state for Rx and Tx frequencies, the UE can apply dynamic thresholds to offset Rx measurements (which are measured with Rx tuner states) to estimate the Tx tuner state efficiency of the antenna. For example, if there is a frequency separation (e.g., gap) between an Rx frequency band and a Tx frequency band, the UE may configure separate tuner states for downlink Rx operations and uplink Tx operations. As a result, Rx measurements (e.g., RSRP, SNR) and Tx measurements may vary based on the tuner state/configuration of the UE. To account for this variability, the UE may adjust the Rx measurements themselves (e.g., RSRP, SNR) or the corresponding thresholds to estimate Tx channel conditions with greater accuracy. These adjusted measurements and/or thresholds can be used for Tx port down-selection. With respect to the dynamic time for down-selection, once a particular antenna is down-selected as a candidate Tx port, the UE may continue to use that Tx port for a period of time (X ms), provided the network configuration for that Tx port does not change. The time period (X ms) may be defined using a dynamic timer that depends on the mobility or doppler state of the UE.

In the flowchart 300A of FIG. 3A, the UE may measure (302) the RSRP of all antenna ports. If there is an RSRP imbalance between some of the antenna ports, the UE may select the antenna ports with the highest RSRP and the lowest imbalance. If there is a difference in TRP between the antenna ports, those with the lowest TRP can be eliminated from consideration. If a BPS detects that one or more of the antenna ports are occluded or obstructed (e.g., by a user or obstacle), the UE may select the antenna port(s) that are not occluded. For example, if a user has a left hand grip on the UE, antenna ports A, B, and D may be down-selected (304). If the UE is tuner-state aware, the UE may compensate for the tuner efficiency delta due to having different tuner states for Rx and Tx operations. For some FDD frequency bands where uplink and downlink frequencies are separated by a frequency gap, an uplink frequency specific tuner state can be applied to the particular antenna port, which helps re-tune the antenna to be effective in this particular uplink frequency. But during evaluation, all of the antenna ports are tuned via downlink frequency specific tuning, where the UE can estimate the approximate gain/delta which could be attained with uplink frequency specific tuning. These gains, which are derived from existing data/measurements, may be retrieved by the UE from a database and applied to the tuner.

In the flowchart 300B of FIG. 3B, the UE may implement a tuner state compensation algorithm to account for the delta between Rx and Tx tuner states. For example, if there are independent Tx/Rx tuner states configured for the current frequency band, the UE may offset (306) the Rx-Tx efficiency delta to account for the difference in tuner states.

In the flowchart 300C of FIG. 3C, the UE may dynamically configure or change (310) the time to evaluate the Tx port based on determining (308) the channel state of the UE. For a stable channel with low interference, the UE may reduce the evaluation time by X ms and continue using the current Tx port. For a stable channel in a stationary environment (e.g., low mobility), the UE may reduce the evaluation time by X ms and continue using the current Tx port. For high doppler scenarios (e.g., mobility or pedestrian), the UE can increase the evaluation time by Y ms for best port selection. For high speed train (HST) scenarios with high doppler shift, the UE can increase the evaluation time by Y +Z ms for best port selection.

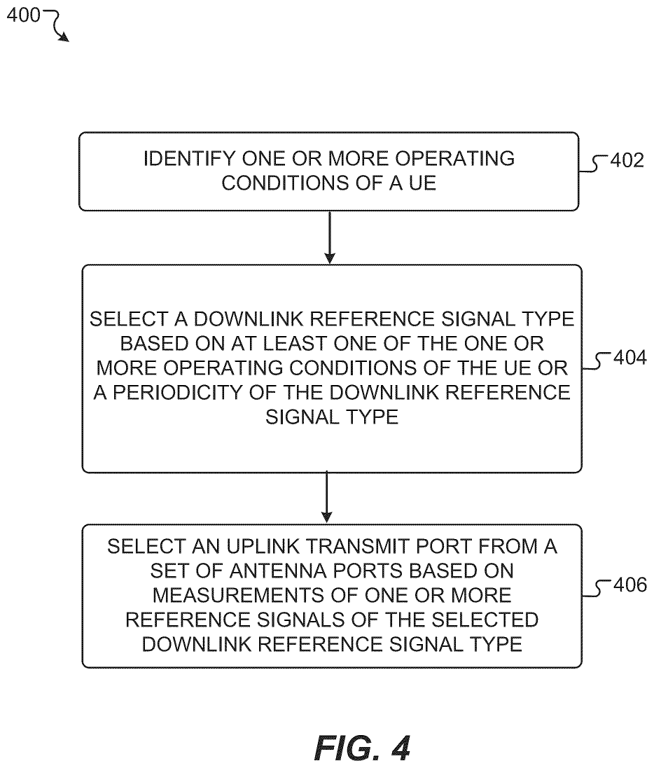

FIG. 4 illustrates a flowchart of another example method 400 for antenna port selection, according to some implementations. For clarity of presentation, the method 400 is described in the context of the preceding figures. For example, the method 400 can be performed by the UE 102 of FIG. 1, or any suitable system, environment, software, hardware, or combination thereof. In some implementations, operations of the method 400 can be run in parallel, in combination, in loops, or in any order. The example method 400 shown in FIG. 4 can be modified or reconfigured to include additional, fewer, or different steps (not shown in FIG. 4), which can be performed in the order shown or in a different order.

At 402, the method 400 includes identifying one or more operating conditions of a UE.

At 404, the method 400 includes selecting a downlink reference signal type based on at least one of the one or more operating conditions of the UE or a periodicity of the downlink reference signal type.

At 406, the method 400 includes selecting an uplink transmit port from a set of antenna ports based on measurements of one or more reference signals of the selected downlink reference signal type.

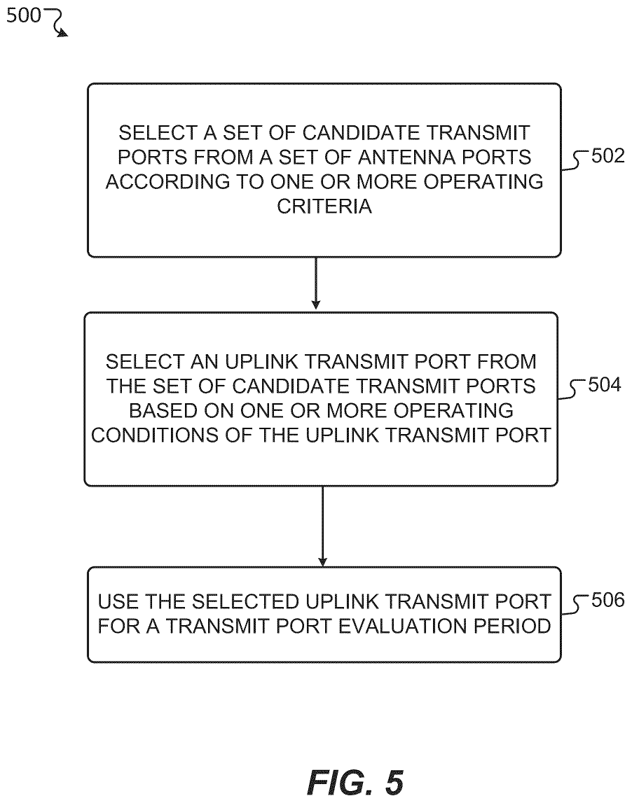

FIG. 5 illustrates a flowchart of another example method 500 for antenna port selection, according to some implementations. For clarity of presentation, the method 500 is described in the context of the preceding figures. For example, the method 500 can be performed by the UE 102 of FIG. 1, or any suitable system, environment, software, hardware, or combination thereof. In some implementations, operations of the method 500 can be run in parallel, in combination, in loops, or in any order. The example method 500 shown in FIG. 5 can be modified or reconfigured to include additional, fewer, or different steps (not shown in FIG. 5), which can be performed in the order shown or in a different order.

At 502, the method 500 includes selecting a set of candidate transmit ports from a set of antenna ports according to one or more operating criteria.

At 504, the method 500 includes selecting an uplink transmit port from the set of candidate transmit ports based on one or more operating conditions of the uplink transmit port.

At 506, the method 500 includes using the selected uplink transmit port for a transmit port evaluation period.

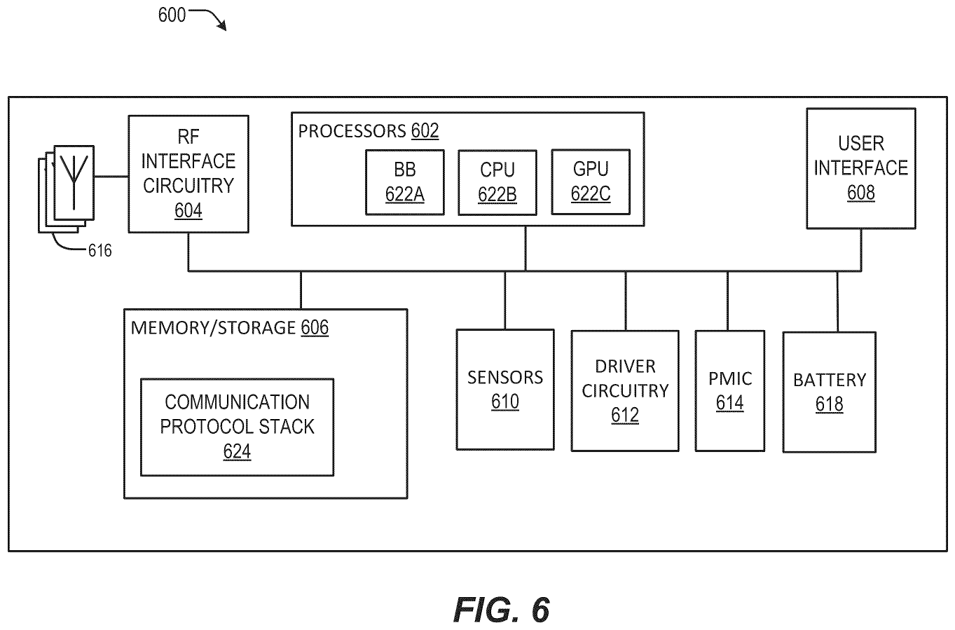

FIG. 6 illustrates an example UE 600. The UE 600 may be similar to and substantially interchangeable with UE 102 of FIG. 1. The UE 600 may include any mobile or non-mobile computing device, such as, for example, a mobile phone, computer, tablet, industrial wireless sensors, video device (for example, cameras, video cameras, and the like), wearable devices (for example, a smart watch), relaxed-IoT devices, etc.

The UE 600 may include any/all of processor 602, RF interface circuitry 604, memory/storage 606, user interface 608, sensors 610, driver circuitry 612, Power Management Integrated Circuit (PMIC) 614, one or more antenna(s) 616, and battery 618. The components of the UE 600 may be implemented as Integrated Circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and a different arrangement of the components shown may occur in other implementations.

The components of the UE 600 may be coupled with various other components over one or more interconnects 620, which may represent any type of interface, input/output, bus (local, system, or expansion), transmission line, trace, optical connection, etc., that allows various circuit components (on common or different chips or chipsets) to interact with one another.

The processor 602 may include one or more processors. For example, the processor 602 may include processor circuitry such as, for example, Baseband (BB) processor circuitry 622A, Central Processor Unit (CPU) circuitry 622B, and Graphics Processor Unit (GPU) circuitry 622C. The processor 602 may include any type of circuitry or processor circuitry that executes or otherwise operates computer-executable instructions, such as program code, software modules, or functional processes from memory/storage 606 to cause the UE 600 to perform operations as described herein.

In some implementations, the baseband processor circuitry 622A may access a communication protocol stack 624 in the memory/storage 606 to communicate over a 3GPP compatible network. In general, the baseband processor circuitry 622A may access the communication protocol stack to: perform user plane functions at a Physical (PHY) layer, Medium Access Control (MAC) layer, Radio Link Control (RLC) layer, Packet Data Convergence Protocol (PDCP) layer, Service Data Adaptation Protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 604. The baseband processor circuitry 622A may generate or process baseband signals or waveforms that carry information in 3GPP-compatible networks. In some implementations, waveforms for NR may implement Cyclic Prefix Orthogonal Frequency Division Multiplexing (CP-OFDM) in the uplink or downlink, and Discrete Fourier Transform Spread Orthogonal Frequency Division Multiplexing (DFT-S-OFDM) in the uplink.

The memory/storage 606 may include one or more non-transitory, computer-readable media that includes instructions (for example, communication protocol stack 624) that may be executed by the processor 602 to cause the UE 600 to perform various operations described herein. The memory/storage 606 include any type of volatile or non-volatile memory that may be distributed throughout the UE 600. In some implementations, some of the memory/storage 606 may be located on the processor 602 itself (for example, Layer 1 “L1” and Layer 2 “L2” caches), while other memory/storage 606 is external to the processor 602 but accessible thereto via a memory interface. The memory/storage 606 may include any suitable volatile or non-volatile memory such as, but not limited to, Dynamic Random Access Memory (DRAM), Static Random Access Memory (SRAM), Erasable Programmable Read-Only Memory (EPROM), Electrically Erasable Programmable Read-Only Memory (EEPROM), Flash memory, solid-state memory, or any other type of memory device technology.

The RF interface circuitry 604 may include transceiver circuitry and Radio Frequency Front Module (RFEM) that allows the UE 600 to communicate with other devices over a radio access network. The RF interface circuitry 604 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 616 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 616. In various implementations, the RF interface circuitry 604 may be configured to transmit/receive signals in a manner compatible with NR access technologies.

The antenna(s) 616 may include one or more antenna elements to convert electrical signals into radio waves to travel through the air and to convert received radio waves over the air into electrical signals. In some implementations, the antenna elements may be arranged into one or more antenna panels. The antenna(s) 616 may have antenna panels that are omnidirectional, directional, or a combination thereof, to enable beamforming and multiple input, multiple output communications. The antenna(s) 616 may include any/all of microstrip antennas, printed antennas fabricated on the surface of one or more printed circuit boards, patch antennas, phased array antennas, etc. The antenna(s) 616 may have one or more panels designed for one or more specific frequency bands, such as bands in Frequency Range 1 (FR 1 ) or Frequency Range 2 (FR2).

The user interface 608 includes various Input/Output (I/O) devices designed to enable user interaction with the UE 600. The user interface 608 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as Light Emitting Diodes “LEDs” and multi-character visual outputs), or more complex outputs such as display devices or touchscreens (for example, Liquid Crystal Displays “LCDs,” LED displays, quantum dot displays, projectors), with the output of characters, graphics, multimedia objects, and the like being generated or produced from the operation of the UE 600.

The sensors 610 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 612 may include software and hardware elements that operate to control particular devices that are embedded in the UE 600, attached to the UE 600, or otherwise communicatively coupled with the UE 600. The driver circuitry 612 may include individual drivers allowing other components to interact with or control various I/O devices that may be present within, or connected to, the UE 600. For example, driver circuitry 612 may include a display driver to control and allow access to a display device, a touchscreen driver to control and allow access to a touchscreen interface, sensor drivers to obtain sensor readings of sensors 610 and control and allow access to sensors 610, drivers to obtain actuator positions of electro-mechanic components or control and allow access to the electro-mechanic components, a camera driver to control and allow access to an embedded image capture device, audio drivers to control and allow access to one or more audio devices.

The PMIC 614 may manage power provided to various components of the UE 600. In particular, with respect to the processor 602, the PMIC 614 may control power-source selection, voltage scaling, battery charging, or Direct Current (DC)-to-DC conversion.

In some implementations, the PMIC 614 may control, or otherwise be part of, various power saving mechanisms of the UE 600. A battery 618 may power the UE 600, although in some examples the UE 600 may be mounted deployed in a fixed location, and may have a power supply coupled to an electrical grid. The battery 618 may be a lithium ion battery, a metal-air battery, such as a zinc-air battery, an aluminum-air battery, a lithium-air battery, and the like. In some implementations, such as in vehicle-based applications, the battery 618 may be a typical lead-acid automotive battery.

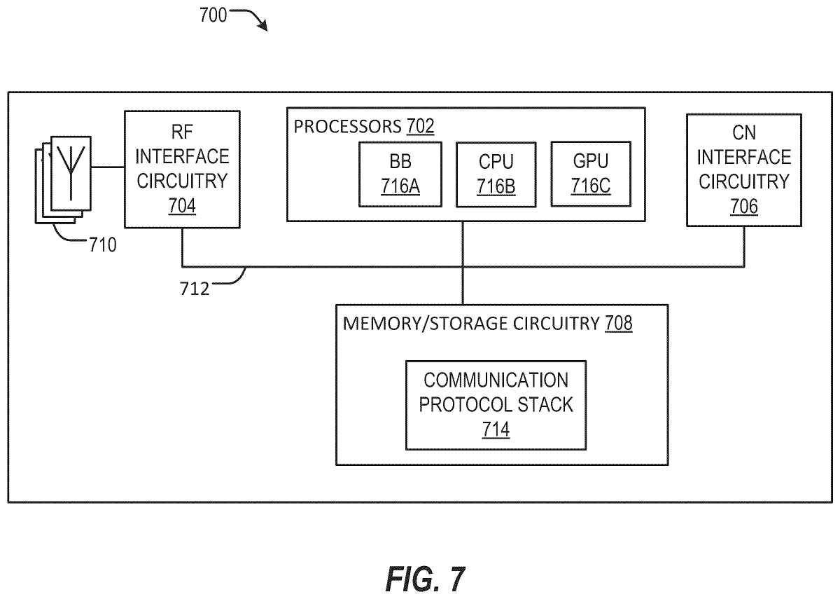

FIG. 7 illustrates an example access node 700 (e.g., a base station or gNB), according to some implementations. The access node 700 may be similar to and substantially interchangeable with base station 104. The access node 700 may include one or more of processor 702, RF interface circuitry 704, Core Network (CN) interface circuitry 706, memory/storage circuitry 708, and one or more antenna(s) 710. The processor 702 may include any type of circuitry or processor circuitry that executes or otherwise operates computer-executable instructions, such as program code, software modules, or functional processes from memory/storage circuitry 708 to cause the access node 700 to perform operations as described herein.

The components of the access node 700 may be coupled with various other components over one or more interconnects 712. The processor 702, RF interface circuitry 704, memory/storage circuitry 708 (including communication protocol stack 714), antenna(s) 710, and interconnects 712 may be similar to like-named elements shown and described with respect to FIG. 6. For example, the processor 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core (5GC) network using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various implementations, the access node 700 may be implemented as one or more of a dedicated physical device such as a macrocell base station, and/or a Low Power (LP) base station for providing femtocells, picocells or other like cells having smaller coverage areas, smaller user capacity, or higher bandwidth compared to macrocells.

In some implementations, all or parts of the access node 700 may be implemented as one or more software entities running on server computers as part of a virtual network, which may be referred to as a CRAN and/or a virtual Baseband Unit Pool (vBBUP). In Vehicle-to-Everything (V2X) scenarios, the access node 700 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below.

Example 1 is a method including: identifying one or more operating conditions of a UE; selecting a downlink reference signal type based on at least one of the one or more operating conditions of the UE or a periodicity of the downlink reference signal type; and selecting an uplink transmit port from a set of antenna ports based on measurements of one or more reference signals of the selected downlink reference signal type.

Example 2 includes the method of example 1, further including receiving an RRC message that configures a set of downlink reference signal types for the UE, where the downlink reference signal type is selected from the set of downlink reference signal types configured by the RRC message.

Example 3 includes the method of example 2, where the periodicity of the selected downlink reference signal type is shorter than other downlink reference signal types configured by the RRC message.

Example 4 includes the method of any of examples 1 to 3, where selecting the downlink reference signal type based on the one or more operating conditions of the UE includes: determining that (i) fluctuations of the measurements of the one or more reference signals of the selected downlink reference signal type over an evaluation period are below a threshold value, and (ii) fluctuations of measurements of reference signals of another downlink reference signal type over the evaluation period are above the threshold value. In some examples, the fluctuations of the measurements include variations between successive measurements obtained at multiple time intervals within the evaluation period, the variations corresponding to at least one of: (i) a difference between a maximum measurement value and a minimum measurement value observed during the evaluation period, (ii) a standard deviation of the measurements over the evaluation period, or (iii) a rate of change of the measurements over the evaluation period.

Example 5 includes the method of any of examples 1 to 4, where identifying the one or more operating conditions of the UE includes determining that the UE is in at least one of a stable channel state with low interference, a stable channel state with high interference, a high Doppler or mobility state, or a reduced transmit power state.

Example 6 includes the method of any of examples 1 to 5, where the one or more operating conditions of the UE are determined based on at least one of an MTPL, an uplink BLER, a downlink BLER, an RSRP, an SNR, a Doppler shift, or a number of uplink acknowledgement failures.

Example 7 includes the method of any of examples 1 to 6, where the selected downlink reference signal type includes one of an SSB, a TRS, a CSI-RS, a DMRS, or a PTRS.

Example 8 includes the method of any of examples 1 to 7, further including transmitting a request for additional transmissions of the selected downlink reference signal type based on the one or more operating conditions of the UE.

Example 9 is a baseband processor configured to perform the method of any of examples 1-8.

Example 10 is an apparatus including: one or more processors; and memory storing instructions that, when executed by the one or more processors, cause the apparatus to perform the method of any of examples 1-8.

Example 11 is a non-transitory computer-readable medium storing instructions that, when executed, cause one or more processors to perform the method of any of examples 1-8.

Example 12 is a method including: selecting a set of candidate transmit ports from a set of antenna ports according to one or more operating criteria; selecting an uplink transmit port from the set of candidate transmit ports based on one or more operating conditions of the uplink transmit port; and using the selected uplink transmit port for a transmit port evaluation period.

Example 13 includes the method of example 12, where selecting the set of candidate transmit ports includes selecting two or more antenna ports with a lowest received power imbalance across the set of antenna ports.

Example 14 includes the method of any of examples 12 to 13, where selecting the set of candidate transmit ports includes excluding an antenna port with a lowest TRP level from the set of candidate transmit ports.

Example 15 includes the method of any of examples 12 to 14, where selecting the set of candidate transmit ports includes excluding an antenna port from the set of candidate transmit ports based on data provided by a BPS sensor.

Example 16 includes the method of example 15, where the data provided by the BPS sensor indicates that at least a portion of the antenna port is occluded.

Example 17 includes the method of any of examples 12 to 16, further including: measuring an RSRP of one or more downlink reference signals via each antenna port of the set of antenna ports; and adjusting the RSRP to compensate for an efficiency delta between a transmit tuner state and a receive tuner state, where selecting the set of candidate transmit ports is based on the adjusted RSRP.

Example 18 includes the method of example 17, where the efficiency delta is associated with a separation between a first frequency range used for uplink transmission and a second frequency range used for downlink reception.

Example 19 includes the method of any of examples 12 to 18, further including adjusting the transmit port evaluation period based on an operating state of a UE.

Example 20 includes the method of example 19, where adjusting the transmit port evaluation period includes reducing the transmit port evaluation period based on determining that the UE is in a stable channel state with low interference.

Example 21 includes the method of any of examples 19 to 20, where adjusting the transmit port evaluation period includes reducing the transmit port evaluation period based on determining that the UE is stationary with stable channel conditions.

Example 22 includes the method of any of examples 19 to 21, where adjusting the transmit port evaluation period includes increasing the transmit port evaluation period based on determining that the UE is in a mobility or pedestrian mode with high Doppler shift.

Example 23 includes the method of any of examples 19 to 22, where adjusting the transmit port evaluation period includes increasing the transmit port evaluation period based on determining that the UE is in an HST mode with high Doppler shift.

Example 24 is a baseband processor configured to perform the method of any of examples 12-23.

Example 25 is an apparatus including: one or more processors; and memory storing instructions that, when executed by the one or more processors, cause the apparatus to perform the method of any of examples 12-23.

Example 26 is a non-transitory computer-readable medium storing instructions that, when executed, cause one or more processors to perform the method of any of examples 12-23.

Any of the foregoing examples can be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For example, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For example, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

We claim:

1. A method comprising:
identifying one or more operating conditions of a user equipment (UE);
selecting a downlink reference signal type based on at least one of the one or more operating conditions of the UE or a periodicity of the downlink reference signal type; and
selecting an uplink transmit port from a plurality of antenna ports based at least in part on measurements of one or more reference signals of the selected downlink reference signal type.

2. The method of claim 1, comprising receiving a Radio Resource Control (RRC) message that configures a plurality of downlink reference signal types for the UE, wherein the downlink reference signal type is selected from the plurality of downlink reference signal types configured by the RRC message.

3. The method of claim 2, wherein the periodicity of the selected downlink reference signal type is shorter than other downlink reference signal types configured by the RRC message.

4. The method of claim 1, wherein selecting the downlink reference signal type based on the one or more operating conditions of the UE comprises:
determining that (i) fluctuations of the measurements of the one or more reference signals of the selected downlink reference signal type over an evaluation period are below a threshold value, and (ii) fluctuations of measurements of reference signals of another downlink reference signal type over the evaluation period are above the threshold value.

5. The method of claim 4, wherein the fluctuations of the measurements comprise variations between successive measurements obtained at a plurality of time intervals within the evaluation period, the variations corresponding to at least one of: (i) a difference between a maximum measurement value and a minimum measurement value observed during the evaluation period, (ii) a standard deviation of the measurements over the evaluation period, or (iii) a rate of change of the measurements over the evaluation period.

6. The method of claim 1, wherein identifying the one or more operating conditions of the UE comprises determining that the UE is in at least one of a stable channel state with low interference, a stable channel state with high interference, a high Doppler or mobility state, or a reduced transmit power state.

7. The method of claim 1, wherein the one or more operating conditions of the UE are determined based on at least one of a Maximum Transmit Power Level (MTPL), an uplink Block Error Rate (BLER), a downlink BLER, a Reference Signal Received Power (RSRP), a Signal to Noise Ratio (SNR), a Doppler shift, or a number of uplink acknowledgement failures.

8. The method of claim 1, wherein the selected downlink reference signal type comprises one of a Synchronization Signal Block (SSB), a Tracking Reference Signal (TRS), a Channel State Information Reference Signal (CSI-RS), a Demodulation Reference Signal (DMRS), or a Phase Tracking Reference Signal (PTRS).

9. The method of claim 1, comprising transmitting a request for additional transmissions of reference signals of the selected downlink reference signal type based at least in part on the one or more operating conditions of the UE.

10. A method comprising:
selecting a set of candidate transmit ports from a plurality of antenna ports according to one or more operating criteria;
selecting an uplink transmit port from the set of candidate transmit ports based at least in part on one or more operating conditions of the uplink transmit port; and
using the selected uplink transmit port for a transmit port evaluation period.

11. The method of claim 10, wherein selecting the set of candidate transmit ports comprises selecting two or more antenna ports with a lowest received power imbalance across the plurality of antenna ports.

12. The method of claim 10, wherein selecting the set of candidate transmit ports comprises excluding an antenna port with a lowest Total Radiated Power (TRP) level from the set of candidate transmit ports.

13. The method of claim 10, wherein selecting the set of candidate transmit ports comprises excluding an antenna port from the set of candidate transmit ports based at least in part on data provided by a Body Proximity Sensing (BPS) sensor.

14. The method of claim 13, wherein the data provided by the BPS sensor indicates that at least a portion of the antenna port is occluded.

15. The method of claim 10, comprising:
measuring a Reference Signal Received Power (RSRP) of one or more downlink reference signals via each antenna port of the plurality of antenna ports; and
adjusting the RSRP to compensate for an efficiency delta between a transmit tuner state and a receive tuner state, wherein selecting the set of candidate transmit ports is based at least in part on the adjusted RSRP.

16. The method of claim 15, wherein the efficiency delta is associated with a separation between a first frequency range used for uplink transmission and a second frequency range used for downlink reception.

17. The method of claim 10, comprising adjusting the transmit port evaluation period based at least in part on an operating state of a user equipment (UE).

18. The method of claim 17, wherein adjusting the transmit port evaluation period comprises reducing the transmit port evaluation period based at least in part on determining that the UE is in a stable channel state with low interference.

19. The method of claim 17, wherein adjusting the transmit port evaluation period comprises reducing the transmit port evaluation period based at least in part on determining that the UE is stationary with stable channel conditions.

20. An apparatus comprising:
one or more processors; and
memory storing instructions that, when executed by the one or more processors, cause the apparatus to perform operations comprising:
identifying one or more operating conditions of a user equipment (UE);
selecting a downlink reference signal type based on at least one of the one or more operating conditions of the UE or a periodicity of the downlink reference signal type; and
selecting an uplink transmit port from a plurality of antenna ports based at least in part on measurements of one or more reference signals of the selected downlink reference signal type.
